(19) United States
(12) Patent Application Publication
(10) Pub. No.: US 2017/0093896 A1
(43) Pub. Date: Mar. 30, 2017

(54) TECHNIQUES FOR RADIO FREQUENCY IDENTIFICATION (RFID) INPUT/OUTPUT (I/O) PORT MANAGEMENT

(71) Applicant: Intel Corporation, Santa Clara, CA (US)

(72) Inventors: RAJESH POORNACHANDRAN, PORTLAND, OR (US); KARUNAKARA KOTARY, PORTLAND, OR (US); VINCENT ZIMMER, FEDERAL WAY, WA (US); RONALD STORY, HILLSBORO, OR (US)

(73) Assignee: Intel Corporation, Santa Clara, CA (US)

(21) Appl. No.: 14/866,327

(22) Filed: Sep. 25, 2015

(51) Int. Cl. H04L 29/06; G06F 12/14; G06F 21/57; H04B 5/00

(52) U.S. Cl. CPC H04L 63/1425; H04B 5/0062; H04L 63/0876; G06F 12/1408; G06F 21/575

(57) ABSTRACT

Various embodiments are generally directed to an apparatus, method and other techniques to receive port configuration information from a radio frequency identification (RFID) device, the port configuration information indicating whether one or more I/O ports are permitted or unpermitted for use and perform a verification of an I/O port of one or more I/O ports based on the port configuration information stored in the RFID device. Embodiments also include causing an action to occur based on whether the I/O port has been verified or not verified.

### TECHNICAL FIELD

Embodiments described herein generally relate to techniques to manage I/O port configuration. Specifically, this disclosure is related to network independent secure server port manageability.

### BACKGROUND

In clustered, enterprise environments today, such as those found in server farms, the configuration, management, and security monitoring of one or more servers in a server farm is an arduous task. Moreover, performing configuration updates, remote management, and security monitoring on a platform level of components, such as I/O ports, is a huge challenge. For example, an attacker may gain access to a server and attach a device via an I/O port to take secure information. These types of attacks are typically hard to detect before a large amount of data has been compromised. Moreover, current server management and monitoring systems provide little to detect these type of attacks and provide secure remote configuration and management.

### BRIEF DESCRIPTION OF THE DRAWINGS

FIG. 1A illustrates an embodiment of a device.

FIG. 1B illustrates an embodiment of a RFID device.

FIG. 2 illustrates an embodiment of a first flow diagram.

FIG. 3 illustrates an embodiment of a second flow diagram.

FIG. 4 illustrates an embodiment of a third flow diagram.

FIG. 5 illustrates an embodiment of a fourth flow diagram.

FIG. 6A illustrates an embodiment of a system.

FIG. 6B illustrates an embodiment of a processing flow diagram.

FIG. 7 illustrates an embodiment of a fifth flow diagram.

FIG. 8 illustrates an embodiment of a device.

FIG. 9 illustrates an embodiment of a computing architecture.

### DETAILED DESCRIPTION

Generally, embodiments may include a system, apparatus, and techniques to perform network independent secure server port manageability. More specifically, embodiments include configuring, managing, and monitoring one or more I/O ports of a computing system by utilizing a radio frequency identification (RFID) device. For example, port configuration information for one or more I/O ports may be stored in a memory of the RFID device indicating whether each of the one or more I/O ports is permitted or unpermitted for use. In embodiments, the RFID device may include information indicating permitted I/O ports in a white list, unpermitted I/O ports in a black list, and I/O port information in a board identify structure (BIS). The BIS may also include a platform identification (ID) to uniquely identify a platform or device that may be utilized for platform level management.

The port configuration information stored in the RFID device may be used in performing a verification of the one or more I/O ports. For example, a controller may determine whether an I/O port is verified to be enabled or disabled based on information stored in a white list or black list in the memory of the RFID device. If an I/O port is verified, the system may be permitted to operate in a normal manner. However, if the I/O port is not verified, one or more actions may be taken.

For example, an alert and/or a log may be generated and communicated to another device, e.g. from the server to the remote device, or vice versa. In another example, the specific I/O port may be disable and/or the entire platform including the I/O port may be disabled. Embodiments are not limited to these examples.

In some embodiments, the verification may be performed by a remote device via one or more network connections. For example, a hash value of the port configuration information may be communicated to the remote device over network connects, the hash value may be used to verify the port configuration information by comparing the hash value to a previously verified hash value.

Embodiments may also be directed to performing configuration and management of the I/O ports via a remote device. For example, a remote device may communicate update information to a RFID reader/writer which may be communicated to the platform including the RFID device and a controller. The controller may receive the update information, verify the update information based on a signature, and enable one or more write operations communicated by the RFID reader/writer to update the port configuration information in the RFID device. These and other details will become more apparent in the following description.

Various embodiments also relate to an apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

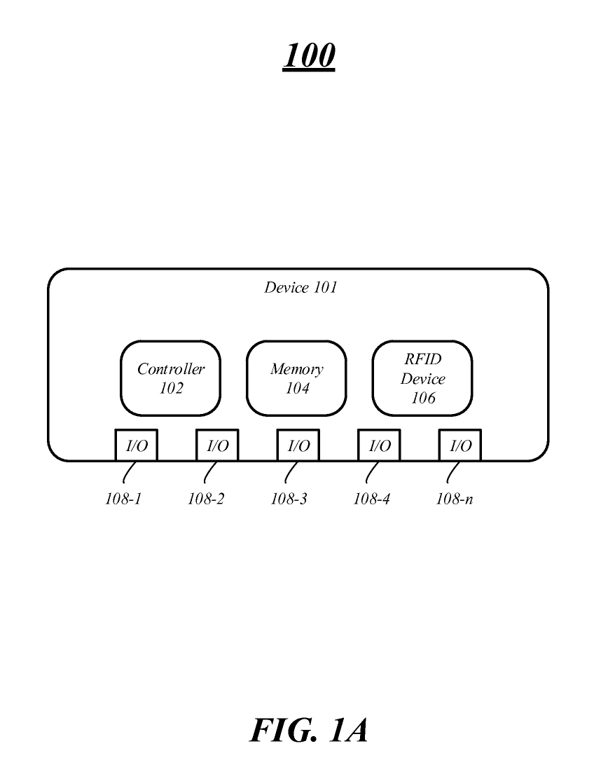

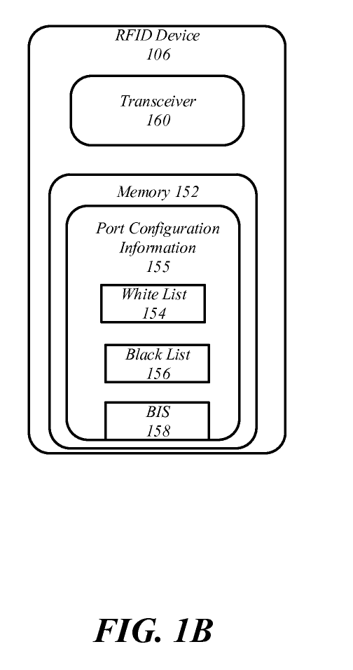

FIG. 1A illustrates an embodiment of a device 101 to process information and data. In some embodiments, device 101 may include a number of components, modules and processing circuitry to process information and instructions for Input/Output (I/O) port manageability. In some embodiments, the device 101 may be computer device, such as a server having an Intel® Architecture (IA). However, embodiments are not limited to this example and device 101 may be any type of device, server, system, and so forth. For example, in some embodiments, device 101 may be a computer including a personal computer, desktop computer, tablet computer, netbook computer, notebook computer, laptop computer, a server, a server farm, blade server, a symmetric multiprocessor (SMP) server, or any other type of server, and so forth. Device 101 includes component such as a controller 102, memory 104, a RFID device 106, and one or more I/O ports 108-n, where n may be any positive integer greater than one (1). FIG. 1A illustrates device 101 having limited number of components for illustrative purposes only and embodiments are not limited in this manner. The device 101 may include any number of components.

In some embodiments, the controller 102 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The controller 102 may be connected to and communicate with the other elements of the device 101 via interconnects (now shown), such as one or more buses, control lines, and data lines. In some embodiments, the controller 102 may include processor registers or a small amount of storage available the processing units to store information including instructions that and can be accessed during execution. Moreover, processor registers are normally at the top of the memory hierarchy, and provide the fastest way to access data.

The device 101 includes memory 104 to store information. Further, memory 104 may be implemented using any machine-readable or computer-readable media capable of storing data, including both volatile and non-volatile memory. In some embodiments, the machine-readable or computer-readable medium may include a non-transitory medium. The embodiments are not limited in this context. The memory 104 may be a secure memory or have a portion dedicated as secure.

The memory 104 can store data momentarily, temporarily, or permanently. The memory 104 stores instructions and data for device 101. The memory 104 may also store temporary variables or other intermediate information while the one or more controller 102 is executing instructions. In some embodiments, information and data may be loaded from memory 104 into the computing registers during processing of instructions by controller 102. Manipulated data is then often stored back in memory 104, either by the same instruction or a subsequent one. The memory 104 is not limited to storing the above discussed data; the memory 104 may store any type of data.

The device 101 also includes an RFID device 106 which, in some embodiments may be an Intel's® Wireless Credential Exchange (WCE) device also known as a Processor Secure Storage (PSS) device. The RFID device 106 is capable of securely storing information and data and providing secure reading and writing capabilities using RFID technology. In embodiments, the RFID Device 106 uses wireless electromagnetic fields to transfer data and permit interrogation of memory in an RFID frequency or frequency range. Further, the RFID frequency may be a particular frequency or a frequency within a range of frequencies in accordance with one or more standards. For example, the RFID frequency may be any frequency with in low frequency (LF) range of 125 kilohertz (kHz)-134 kHz, a high frequency (HF) of 13.56 megahertz (MHz), and an Ultra-High Frequency (UHF) frequency of 433 MHz or within a frequency range of 860 MHz-960 MHz. Embodiments are not limited in this manner and other frequencies may be contemplated based on one or more standards and/or country of deployment.

The RFID device 106 may be coupled with one or more other components of the device 101 via one or more interconnects and can receive power from a power source of the device 101, such as a battery or a power supply. In some embodiments, the RFID device 106 may be coupled with one or more other components via an inter-integrated circuit (I²C or I2C) bus. As will be discussed in more detail below with respect to FIG. 1B, the RFID device 106 may include secure memory to store port configuration information indicating whether the one or more I/O ports 108-n are permitted or unpermitted for use.

In embodiments, the device 101 also includes one or more I/O ports 108-n which may be any device having circuitry for processing information and communications over wireless and wired connections. For example, the one or more I/O ports 108-n may include a Universal Serial Bus (USB) ports, IEEE 1394 Firewire ports, Serial ports, parallel ports, printer port, Centronics ports, PS/2 port, a VGA port, a DVI port, an HDMI port, audio port, MIDI port, RG-6 port, a DisplayPort® port, a Gigabit Ethernet port, a hot pluggable storage port, and so forth. In some embodiments, the I/O port 108 may include a receiver, a transmitter, one or more antennas, and/or one or more Ethernet connections. The specific design and implementation of the I/O ports 108-n may be dependent upon the communications network in which the device 101 is intended to operate.

In embodiments, the device 101 including the controller 102 may process information and control various aspects of the device 101, such as I/O port 108-n manageability. For example, the controller 102 may verify each of the one or more I/O ports 108-n on a platform or device level to ensure that they are permitted to be enabled or disabled using port configuration information stored in the RFID device 106. The controller 102 may also verify each I/O port 108-n on a port-by-port basis using the port configuration information stored in the RFID device 106.

In one example, the controller 102 may determine whether an I/O port 108-n is verified or permitted to be enabled based on the port configuration information including information stored in a white list in secure memory of the RFID device 106. The white list may store identifications for one or more I/O ports 108-n of the device 101 that are permitted to be enabled. The controller 102 may compare an identification of an I/O port 108-n attempting to be enabled with the information in the white list to determine if the I/O port is permitted to be enabled. If the I/O port is on the white list the I/O port 108-n may be verified. If the I/O port is not on the white list or is on the black list it may not verified.

In another example, an I/O port 108-n may attempt to be disabled and the controller 102 may compare an identification of the I/O port 108-n with information on a black list including information identifying one or more I/O ports 108-n that are permitted to be disabled. If the I/O port 108-n is listed on the black list it may be verified. However, if the I/O device is not listed on the black list and/or is listed on the white list, the I/O port may not be verified.

In some embodiments, the controller 102 may verify an I/O port 108-n based on information stored in a board identity structure (BIS). For example, the BIS may include information indicating whether the I/O port 108-n is to be enabled or disabled based on a particular time and/or location of the I/O port 108-n. For example, the operation of the I/O port 108-n may be time sensitive and can only be enabled during certain hours of the day. If the I/O port 108-n is attempting to be enabled or is enabled during those particular hours it may be verified. However, if the I/O port 108-n is attempting to be enabled or is enabled outside of those hours it may not be verified. In another example, the enablement of the I/O port-n may be location sensitive and can only be enabled if located within a specific geographic region, defined area, building, and so forth. The location of the I/O port-n may be determined by any location determination means, such as a geographic position system (GPS) (not shown) associated with the I/O port 108-n.

In some embodiments, the BIS may have a platform identification (ID) to uniquely identify a platform or device 101. The BIS can also include a number of platform element descriptors. Each of the I/O ports 108-n may be associated with a platform element descriptor having global identifiers such as an element ID to identify the I/O port and a manufacture ID to identify a manufacture of the I/O port. The element ID and/or manufacture may be used for comparison during verification. For example, the element ID and/or the manufacture ID of permitted enabled devices may be listed in the white list, while permitted disabled devices may be in the black list. In addition, the platform element descriptor can also include the geographic constraint to limit enablement of an I/O port to specific location(s) and a time constraint to limit enablement of an I/O port a specific time(s), as previously mentioned.

On platform or device level verification, the controller 102 may use the port configuration information of the I/O ports 108-n by verifying the port configuration information stored in memory of the RFID device 106 with previously verified port configuration information For example, the controller 102 may use a hash value of the port configuration information including the board identity in the RFID device 106 and another verified hash value for verified port configuration information stored or provisioned in secure memory of device 101 to ensure the integrity of the port configuration information in the RFID device 106. In some embodiments, the secure memory may be a portion of memory 104 or may be a separate secure memory, such as field-programmable fuses (FPFs) which may be used as a trust anchor by the controller 102 to store a verified hash value of verified port configuration information for the device 101 or platform. Thus, prior to verifying the I/O ports 108-n, the controller 102 may first sign and verify the port configuration information stored in the RFID device 106, by generating a hash value using the port configuration information and comparing the hash value to the provisioned or previously determined and verified hash value in the secure memory. If the hash values match, the controller 102 may proceed with verifying the I/O ports 108-n individually. However, if the hash values do not match, the controller 102 may perform one or more other actions, such as reporting an error to a system administrator, disabling the system, disabling specific I/O ports, generating an event log, and so forth.

The controller 102 may also verify whether each specific I/O port 108 has permission to be enabled (or disabled) based on the verified port configuration information stored in the RFID device 106 during a boot operation. For example, the controller 102 may compare each attempt by an I/O device 108-n to enable against the verified port configuration information stored in the RFID device 106 to determine whether the I/O device 108-n has permission to be enabled or not while the device 101 is ‘booting’. Based on the comparison, the controller 102 may perform any number of different actions.

In another example, the controller 102 may also detect an attempt to enable or disable the one or more I/O ports 108-n during run-time operations. For example, the controller 102 may perform real-time monitoring of each of the I/O ports 108-n to determine whether a device or connector is being plugged into or taken out of any one of the I/O ports 108-n. If the controller 102 detects an attempt to enable or disable a particular I/O port 108-n, the controller 102 may perform a verification using the verified port configuration information stored in the RFID device 106, e.g. performing a comparison with information stored in the white list, black list, and or BIS.

In some embodiments, the controller 102 may generate an interrupt to cause the device 101 to enter a secure mode of operation to verify an I/O port 108-n. In some instances, the interrupt may be a system management interrupt (SMI) and the secure mode of operation may be a unified extensible firmware interface (UEFI) system management mode (SMM). Once in the secure mode of operation, the controller 102 may verify an attempt to enable or disable an I/O port 108-n by comparing an identification of with the port configuration information stored in the memory of the RFID device 106, for example. The controller 102 may take appropriate action based on the outcome of the verification. For example, the controller 102 may enable the I/O port, disable the I/O port, generate an alert, and disable the entire device comprising the controller, the RFID device, and the one or more I/O ports. Embodiments are not limited to these examples and may include other actions that may be performed.

The controller 102 may also enable a remote device to monitor, manage and configure the I/O ports 108-n. A remote device can be consider any device not on the same premises as the device 101 and a local device may be considered any device on the same premises as the device 101. Embodiments include enabling a remote device to verify the I/O ports 108-n at the platform level or individually at the I/O port level. The controller 102 may also enable a remote device to update port configuration stored in the RFID device 106 and a verified hash value stored in the secure memory of the device 101. The controller 102 may also communicate status or alert information to a remote device indicating a current status of a port configuration of device 101 and/or any attempts to enable/disable one or more I/O ports 108-n against port policy based on a verified port configuration. These and other details will become more apparent in the following discussion.

FIG. 1B illustrates an example embodiment of an RFID device 106, which as previously discussed, may include Intel's® WCE architecture and may also be known as a PSS device. The RFID device 106 includes a transceiver 160 to communicate information using an RFID frequency and a memory 152 capable of securely storing information and data and which can be securely read and written to using RFID technology via the transceiver 160. In some embodiments, the memory 152 can be volatile or non-volatile memory and can store port configuration information 155 in a secure or trusted manor. For example, the port configuration information 155 may be encrypted using an encryption technique.

As previously mentioned, the port configuration information 155 can include a white list 154 for permitted I/O port 108-n and a black list 156 for unpermitted I/O device 108-n. Any I/O port 108-n in the white list 154 is permitted for use and any I/O port 108-n in the black list 156 is not permitted for use, for example. Some embodiments may include and/or function with only a white list 154 or black list 156. In some embodiments, information indicating whether an I/O port 108-n is permitted or unpermitted for use may be in a different data structure. Embodiments are not limited in this manner. The port configuration information 155 can also include BIS 158 having the platform ID to uniquely identify a platform or device 101. The BIS 158 also can include a number of platform element descriptors, as previously discussed.

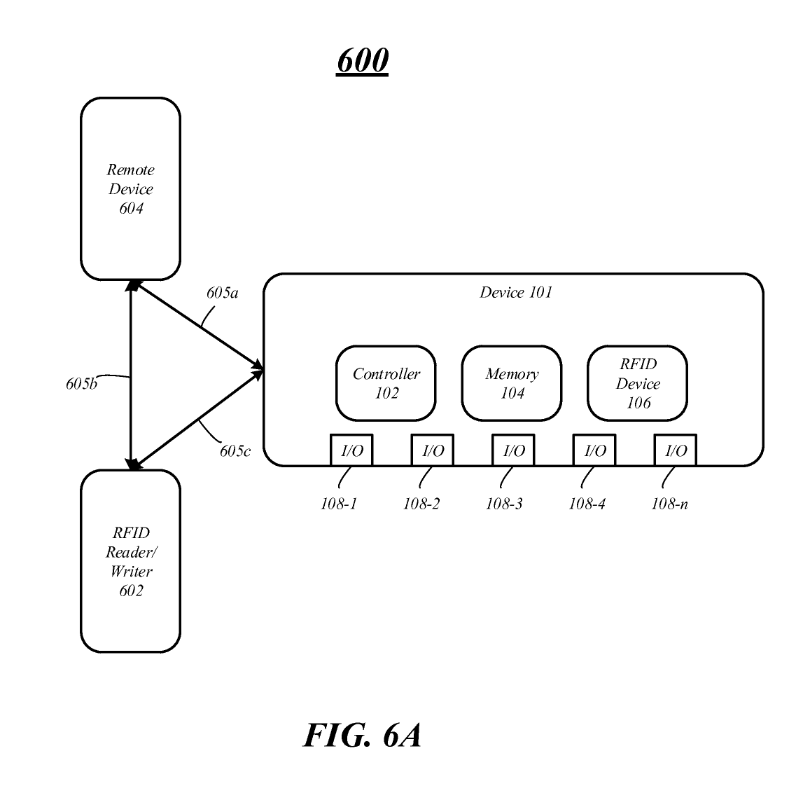

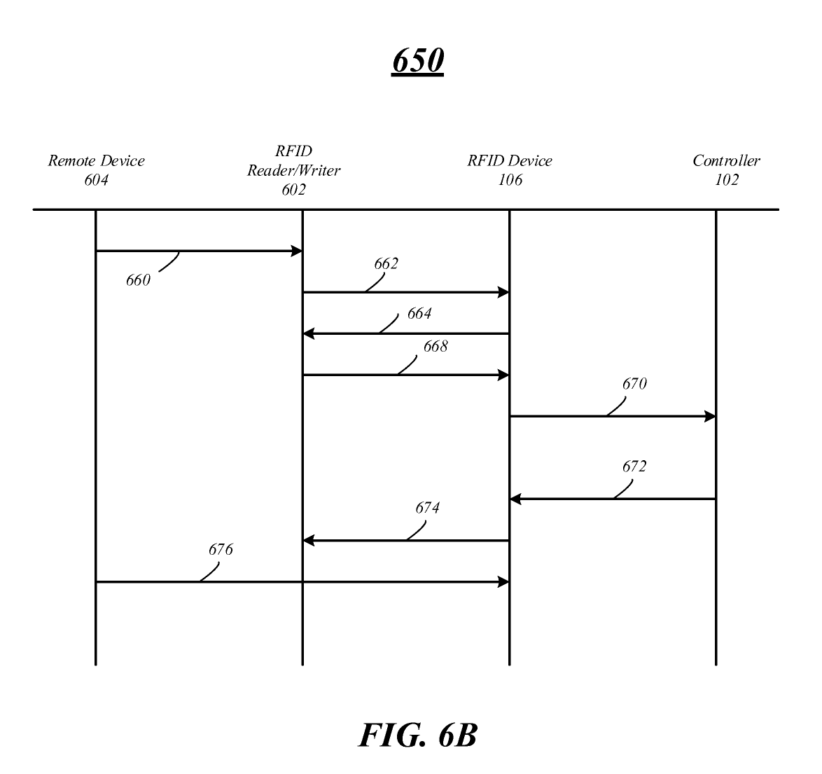

In embodiments, the RFID Device 106 uses wireless electromagnetic fields to transfer data. In some embodiments another RFID device, such as RFID reader/writer (see FIG. 6A) may communicate with the RFID device 106 to read information from and write information to the memory 152. The other RFID device may be located within a housing for device 101 or outside of the housing for device 101. The RFID reader/writer may be located at such a distance from the RFID device 106 to be capable of performing the read/write operations with the memory 152.

In some embodiments, the controller 102 may enable the RFID device 106 to provide the information in memory 152 to the RFID reader/writer, e.g. make it available for reading and writing. In one example, the RFID reader/writer may communicate with the controller 102 to gain permission for accessing memory 152 using a verification technique. The controller 102 may enable or disable reading and writing operations by the RFID device 106 based on the result of the verification technique. In some embodiments, the RFID device 106 may communicate a ‘heartbeat’ signal to the RFID reader/writer to ensure that the RFID device 106 is operating properly. The ‘heartbeat’ signal may be communicated whether power is supplied or not supplied to the device 101 and with or without instruction from the controller 102.

In some embodiments, the RFID reader/writer may read the verified port configuration information 155 from the memory 152 and provide the information via one or more connections to a remote device. A remote device may use this port configuration information 155 to verify a current port configuration for the device 101. As previously mentioned, a remote device may be provisioned with a verified port configuration for use in verification. In some embodiments, the RFID reader/writer may communicate a hash value generated from the port configuration information 155 for remote device verification. In other words, the hash value sent to the remote device may be used by the remote device to perform a remote attestation.

In embodiments, the controller 102 may receive information from a remote device via one or more connections and/or via the RFID reader/writer based on the outcome of the verification. For example, the controller 102 may receive information to disable the device 101 and/or one or more I/O ports 108-n if the port configuration cannot be verified. I another example, the controller 102 may receive information from a remote device indicating that the port configuration has been verified. Embodiments are not limited to these examples.

The controller 102 may also enable writing to the memory 152 of the RFID device 106 by the RFID reader/writer. For example, a remote device may communicate update information for the port configuration information 155 to the RFID reader/writer which may be written to the memory 152. The update information may include new or changes to the white list 154, the black list 156, and/or the BIS 158. These changes may include changes indicating which I/O ports 108-n are permitted to be enabled and which are not permitted to be enabled; and which I/O ports-n are permitted to be disabled and which are not permitted to be disabled.

Each change to the port configuration information 155 stored in the memory 152 can result in a different hash value being generated. Thus, the verified hash value stored in secure memory needs to be updated. In some embodiments, the controller 102 will update the hash value stored in the secure memory and used as a trust anchor each time a change is made to the verified port configuration information 155.

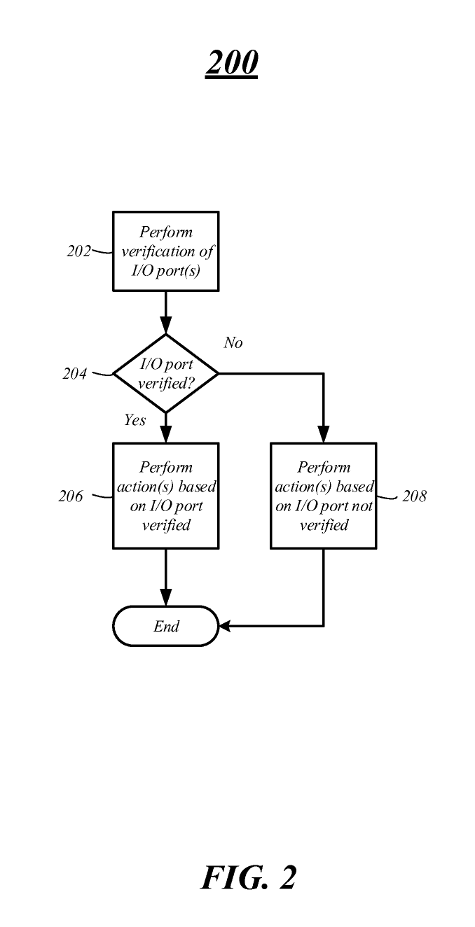

FIG. 2 illustrates an example logic flow 200 to perform a verification of one or more I/O ports, such as I/O ports 108-n previously discussed in FIG. 1A. In embodiments, the operations discussed with respect to logic flow 200 may be performed by the controller 102. However, embodiments are not limited in this manner and at least portions of operations may be performed by other components. In some embodiments, the controller 102 may enable a remote device to perform a remote attestation to verify the one or more I/O ports 108-n.

In some embodiments, the logic flow 200 may include performing a verification of one or more I/O ports 108-n by a controller 102 during a boot operation or during run-time operations at block 202. As mentioned, to verify the one I/O ports 108-n, the controller 102 may compare current port configuration information including an identification for the I/O port 108-n to the verified port configuration information stored in the RFID device 106. For example, the controller 102 may determine whether the I/O ports are configured, e.g. enabled or disabled, correctly based on the verified port configuration information 155 including information in the white list 154, the black list 156, and/or the BIS 158.

As mentioned, the I/O ports 108-n may be verified on a platform level by using a hash value of the current port configuration and another hash value based on the verified port configuration information 155 in the memory 152. Further and in some instances, the controller 102 may perform a verification by enabling a remote device to perform an attestation or verification of the current port configuration. For example, the controller 102 may receive a request to verify the current port configuration of a device 101. In response, the controller 102 may communicate a hash value based on the current port configuration to the remote device to be verified using a verified hash value the remote device had previously received and/or generated. In another example, the controller 102 may send a hash value of the current platform configuration to a remote device for verification without being prompted. More specifically, the controller 102 may enable communication of a hash value to be communicated to the remote device on a periodic basis, semi-periodic basis, and/or a non-periodic basis, for example. In some embodiments, the controller 102 may communicate the current port configuration information to the remote device instead of or with a hash value and the remote device may verify the current port configuration. Embodiments are not limited in this manner.

At block 204, a determination may be made as to whether the current port configuration, e.g. each I/O port is verified or not verified. The controller 102 may determine verification based on the comparison performed locally or by information received from a remote device, as previously discussed.

If the current port configuration is not verified, the controller may perform one or more action(s) based on the I/O ports and configuration not be verified at block 208. For example, the controller 102 may communicate an alert to another device or system, e.g. a local and/or a remote device or system. In another example, the controller 102 may log and/or communicate a log of the event to a local or remote device. In a third example, the controller 102 can disable the platform, e.g. device 101, and/or prevent the platform from booting. In another example, the controller 102 can disable one or more specific I/O ports. Embodiments are not limited in this manner.

If the current port configuration is verified, the controller may perform one or more action at block 206. For example, the controller 102 may continue to permit the device 101 and/or platform to operate in a normal operating manner, e.g. with the current configuration. In some instances, the controller 102 may send a notification to a local or remote device indicating that the current port configuration has been verified. Embodiments are not limited in this manner.

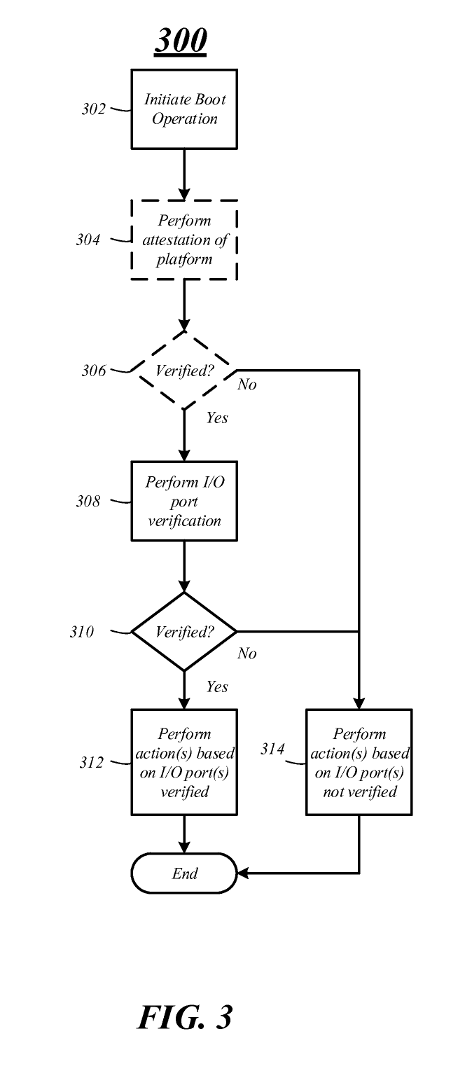

FIG. 3 illustrates an example logic flow 300 for performing verification during a boot operation. In various embodiments, operations discussed with respect to logic flow 300 may at least partially be performed by the controller 102 of the device 101. However, embodiments are not limited in this manner.

The logic flow 300 can include initiating a boot operation at block 302. In some instances, the boot operation initiation may be triggered by a user or person applying power to a device. However, in some instances, the boot operation initiation may be triggered by another device, located either locally or remotely. The boot operation may be implemented by a controller 102 utilizing a UEFI basic input/output system (BIOS), for example. In some embodiment, the UEFI BIOS may operate in a secure system management mode (SMM) of operation when performing the boot operation. Embodiments are not limited to these examples.

At optional block 304, the controller 102 may perform or enable an attestation to be performed to verify the port configuration information 155 stored in the RFID device 106. In performing the attestation a hash value may be generated based on the port configuration information 155 in the memory 152 of the RFID device 106 and compared with a verified hash value stored in secure memory or by a remote device that previously received a verified hash value. In some embodiments, the port configuration information 155 may be communicated to a remote device to enable the remote device to perform the attestation.

At optional decision block 306, the controller 102 determines whether the port configuration information 155 is verified or not verified. If the port configuration information 155 is not verified the controller 102 may perform one or more action(s) based on the I/O ports and configuration not being verified at 314, as previously discussed. For example, the controller 102 may communicate an alert to another device or system, e.g. a local and/or a remote device or system. In another example, the controller 102 may log and/or communicate a log of the event to a local or remote device. In a third example, the controller 102 can disable the platform, e.g. device 101, and/or prevent the platform from booting. In another example, the controller 102 can disable one or more specific I/O ports. Embodiments are not limited in this manner.

If the controller 102 determines the port configuration information is verified, the controller 102 may verify a current port configuration for each of the I/O ports 108-n at block 308. For example, controller 102 may determine whether each of the specific I/O ports 108-n is to be enabled or not enabled based on the information in the white list 154, the black list 156, and the BIS 158, e.g. by performing a comparison. In some instances, the controller 102 may also verify enablement/disablement for each of the I/O ports 108-n based on a time of day or location of the I/O port 108-n (or device 101). More specifically, the controller 102 may compare the BIS 158 information stored in the memory 152 with the current location and/or time of day to determine whether a specific I/O port 108-n is permitted or not permitted to be enabled.

If at least one of the I/O ports 108-n is not verified as determined by the controller 102 at decision block 310, one or more action(s) may be taken at block 314, as previously discussed above. However, if the I/O ports 108-n is verified, the controller may perform one or more action at block 312. For example, the controller 102 may continue to permit the device and/or platform to operate in a normal operating manner, e.g. with the current configuration, and allow the boot operation to complete. In some instances, the controller 102 may send a notification to a local or remote device indicating that the current port configuration has been verified. Embodiments are not limited in this manner.

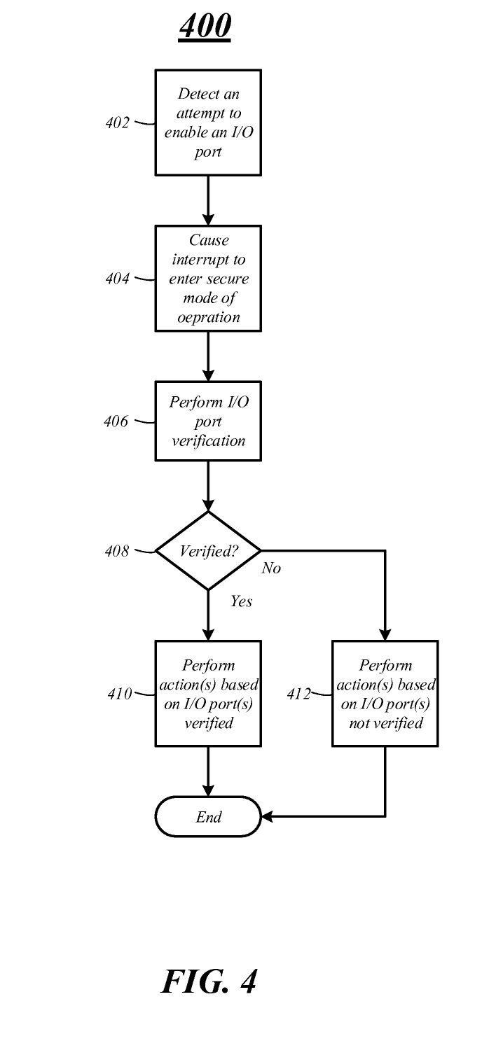

FIG. 4 illustrates an example of a logic flow 400 to perform I/O port verification during run-time operations. In various embodiments, operations discussed with respect to logic flow 400 may at least partially be performed by the controller 102 of the device 101. However, embodiments are not limited in this manner.

At block 402, the logic flow 400 may include detecting an attempt to enable an I/O port. For example, the controller 102 may receive information indicating that a connector may be newly attached to a specific I/O port 108-n. For example, a person may attempt to enable an I/O port 108-n by plugging a connector into the I/O port 108-n. In some embodiments, an attempt to enable a specific I/O port 108-n may be initiated via one or more software instructions communicated to the device 101 or on the device 101. For example, a person may attempt to enable an I/O port 108-n via an input device (e.g. keyboard/mouse) and display device coupled with the device 101 using one or more software instructions. In another example, a user may attempt to enable the I/O port 108-n by using another device to communicate software instructions over one or more connections. Embodiments are not limited in this manner.

At block 404, the controller 102 may cause an interrupt, such as system management interrupt (SMI), to put the device 101 into a secure mode of operation, such as an UEFI BIOS SMM mode. Thus, a verification of the attempt to enable an I/O port 108-n may be performed in a secure manner.

The logic flow 400 may also include performing a verification of the I/O port 108-n by the controller 102 at block 406. In some embodiments, the controller 102 may utilize the UEFI BIOS SMM mode to perform the verification. In performing the verification, the controller 102 may compare an identification or identifier for the I/O port 108-n being enabled with information in previously verified port configuration information 155 to determine if the I/O port 108-n is permitted to be enabled. As mentioned, the port configuration information 155 may first be verified by generating a hash value and comparing the hash value with a previously verified hash value stored in a secure memory. In performing the verification of the I/O Port 108-n, the controller 102 may determine whether the I/O port 108-n is verified based on information in the white list 154, the black list 156, and/or the BIS 158.

At decision block 408, the controller 102 may to determine whether the I/O port 108-n verification is successful or not successful. If the I/O port 108-n is not verified, one or more action(s) may be taken at block 412, as previously discussed above. For example, the controller 102 may forbid the enablement of the I/O port 108-n. However, if the I/O ports 108-n is verified, the controller may perform one or more action at block 410. For example, the controller 102 may continue to permit the device and/or platform to operate in a normal operating manner, e.g. with the current configuration, and allow the enablement of the I/O port 108-n to complete. In some instances, the controller 102 may send a notification to a local or remote device indicating that the current port configuration has been verified. Embodiments are not limited in this manner.

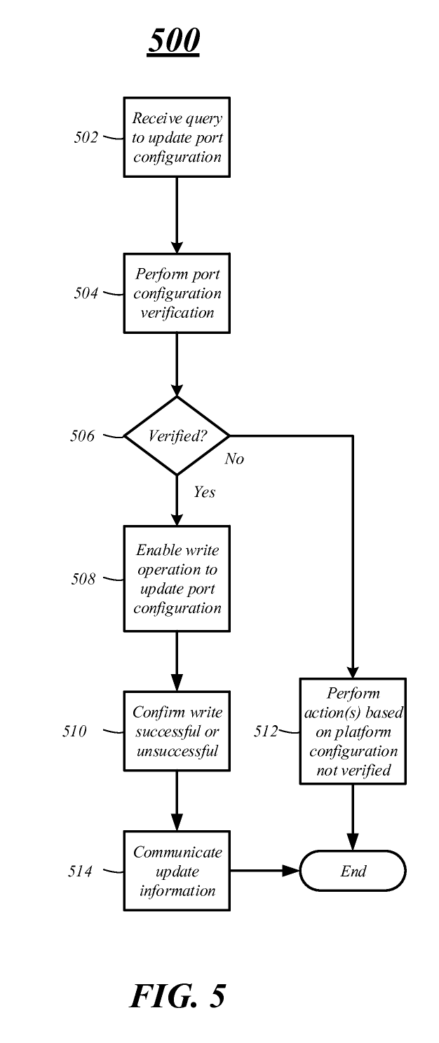

FIG. 5 illustrates an example of a logic flow 500 to update configuration information 155 stored in an RFID device 106. In various embodiments, operations discussed with respect to logic flow 500 may at least partially be performed by the controller 102 of the device 101. However, embodiments are not limited in this manner.

At block 502, the device 101 and/or controller 102 may receive a query or request to update the port configuration information stored in the memory 152 of the RFID device 106. For example, a remote device or local device may communicate a request or query to change information in one or more of the white list 154, the black list 155, and the BIS 158. In one example, the request or query may be communicated over one or more secure connections by a determined secure device. The determined secure device may have been previously authenticated and deemed as trusted device.

The logic flow 500 may include performing a verification of the current port configuration information 155 in the memory 152 of the RFID device 106. In one example, the controller 106 may compare a hash value generated from the current port configuration information 155 with a verified hash value stored in secure memory. In another example, the controller 102 may enable a remote device to perform a verification by communicating a hash value and/or the port configuration information to the remote device. The remote device may perform a comparison based on a verified hash value which may have been previously communicated.

At decision block 506, the controller 102 may to determine whether port configuration information verification is successful or not successful. If not successful, one or more action(s) may be taken at block 510, as previously discussed above. For example, the controller 102 may forbid the updating of the port configuration information 155. The controller 102 may communicate an alert to another device or system, e.g. a local and/or a remote device or system. In another example, the controller 102 may log and/or communicate a log of the event to a local or remote device. In a third example, the controller 102 can disable the platform, e.g. device 101, and/or prevent the platform from booting. In another example, the controller 102 can disable one or more specific I/O ports. Embodiments are not limited in this manner.

If the verification is successful at decision block 506, the controller 102 may enable or permit the RFID device 106 to be written to by another RFID device, such as an RFID reader/writer. The write operation may include communicating one or more bits of information using a RFID frequency to be written in memory 152 of the RFID device 106. The one or more bits of information may including information to update/change the white list 154, the black list 156, and/or the BIS 158.

Further, the controller 102 may confirm whether the write operation was successful or not successful at block 510. If the write operation was successful, the controller may also communicate updated port configuration information and/or hash values at block 514. In embodiments, the controller 102 may generate a new hash value based on the updated port configuration information 155 and communicate it to a remote device to perform attestations and verifications. In some embodiments, the controller 102 may also put the device 101 into a secure mode of operation and update the verified hash value in the secure memory to be used as a trust anchor for verifying the port configuration information 155 in the memory 152.

However, if the I/O ports 108-n is verified, the controller may perform one or more action at block 410. For example, the controller 102 may continue to permit the device and/or platform to operate in a normal operating manner, e.g. with the current configuration, and allow the enablement of the I/O port 108-n to complete. In some instances, the controller 102 may send a notification to a local or remote device indicating that the current port configuration has been verified. Embodiments are not limited in this manner.

FIG. 6A illustrates an example of a system 600 to enable remote device port configuration management. The system 600 may include one or more devices, such as device 101, a RFID reader/writer 602, and a remote device 604. The device 101 may be the same as the liked name device previously discussed above. Further, the remote device 604 may be considered a remote when the device is not on the same premise as the device 101 having the one or more I/O ports 108-n. The RFID reader/writer 602 may be located on the same premises as the device 101. For example, the RFID reader/writer 602 may be located near the device 101 such that it may perform read/write operations with RFID device 106.

In some embodiments, the device 101, the RFID reader/writer 602, and the remote device 604 may be coupled via one or more wired and/or wireless connections 605. In some implementations, each of the connections 605a, 605b, and 605c may be the same connection, the same type of connection, different connections, and/or different types of connections. For example, the device 101 and remote device 604 may communicate via connection 605a via one or more networking connections through networking equipment, such as switches, access points, routers, and so forth. Similarly, the remote device 604 may communicate with the RFID reader/writer 602 via connection 605b via one or more networking connections. However, in the same example, the device 101 and RFID reader/writer 602 may communicate with each other via one or more RF signals using a RFID frequency. Embodiments are not limited to this example.

In embodiments, the device 101 and the remote device 604 may communicate instructions and information between each other to perform remote device port configuration management. For example, the device 101 and the remote device 604 may communicate port configuration information, hash values, verification results and/or requests, alerts, logs, other notifications, and so forth. The remote device 604 may communicate with the device 101 to maintain active knowledge of a current port configuration and system status. Further, the remote device 604 may be used to control various aspects of the device 101 including port enablement and disablement. Embodiments are not limited in this manner, as previously discussed.

The remote device 604 and RFID reader/writer 602 may also communicate instructions and information between each other to perform remote device port configuration management. For instance, the RFID reader/writer 602 may communicate a status update or ‘heartbeat’ signal to the remote device 604 based on information detected and received from the RFID device 106. In some embodiments, the RFID reader/writer 602 may read the RFID device 106 and communicate the read information to the remote device 604. Similarly, the remote device 604 may communicate information to the RFID reader/writer 602 to write to the RFID device 106. In some embodiment, as will be discussed in more detail, the remote device 604 may communicate a request or query to trigger and update of port configuration information stored on the RFID device 106. Embodiments are not limited to these examples.

FIG. 6B illustrates an example of a processing flow 650 to update port configuration in an RFID device 106 by a remote device 604. This processing flow 650 illustrates one example embodiment to provision an update for port configuration information. Various embodiments are not limited to this example and other provisioning techniques may be contemplated.

At line 660, a remote device 604 may communicate a request to update port configuration information on a RFID device 106 to a RFID reader/writer 602. The request may be included with the update to update the port configuration information. In some embodiments, the RFID reader/writer 602 can be an RFID provisioning device located in a server proximate to a device 101 having the RFID device 106. In some embodiments, the RFID reader/writer 602 may be capable of communicating with a number of devices similar to device 101, and therefore, the remote device 604 may communicate an identifier with the request to the RFID reader/writer 602. The RFID reader/writer 602 may use the identifier to locate the correct device 101.

At line 662, the RFID reader/writer 604 queries the RFID device 106 notifying the RFID device 106 the request to update the port configuration information. The RFID device 106 may perform a verification exchange with the RFID reader/writer 604 to verify the port configuration information currently in the RFID device 106 at line 664. At line 668, the RFID reader/writer 604 may communicate the update including a signature to the RFID device 106, and in particular, a memory 152. As previously mentioned, the update may include information to update or change the white list 154, the black list 156, and/or the BIS 158.

The controller 102 may receive the update information and perform a verification to a signature for the update information at line 670. If the verification is indicated as successful at line 672, the RFID device 106 may allow the update information to be written to the memory 152 by the RFID read/writer 602. If the verification is not successful, the update information will not be permitted to be written to the memory 152 of the RFID device 106. At line 674, the RFID device 106 may indicate whether the verification of the signature and/or the write operation were successful to the RFID reader/writer 602, which may be forward to the remote device 604. The remote device 604 may communicate a confirmation at line 676 to the RFID reader/writer 604 which may then secure the RFID device 106.

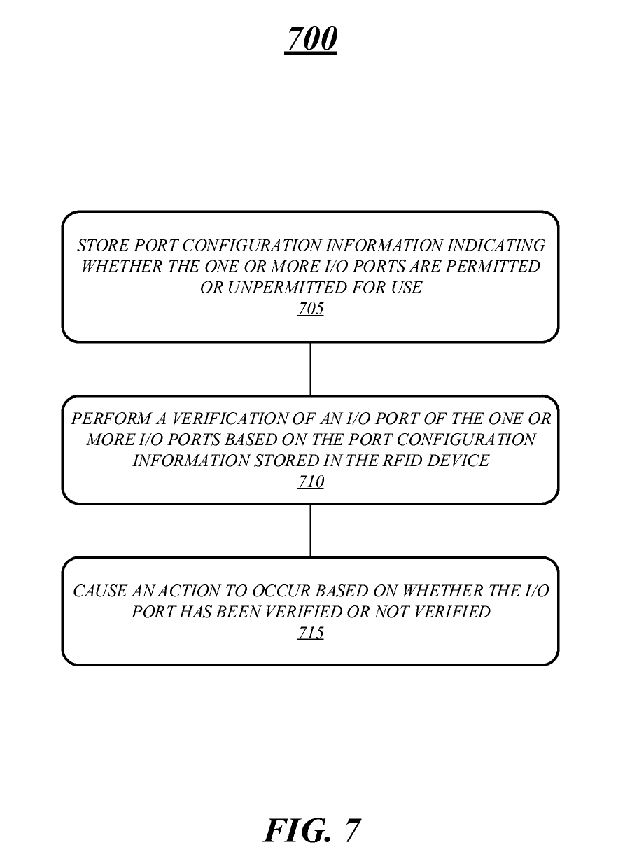

FIG. 7 illustrates an embodiment of a logic flow diagram 700. The logic flow 800 may be representative of some or all of the operations executed by one or more embodiments described herein. For example, the logic flow 700 may illustrate operations performed by one or more systems, devices, and controllers in FIGS. 1-6B. Various embodiments are not limited in this manner.

In various embodiments, the logic flow 700 may include storing port configuration information indicating whether the one or more I/O ports are permitted or unpermitted for use at block 705. The port configuration information may be stored in a memory of an RFID device and include information indicating permitted I/O ports in a white list, unpermitted I/O ports in a black list, and I/O port information in a board identify structure (BIS). The BIS may also include a platform ID to uniquely identify a platform or device and a number of platform element descriptors including the I/O port information.

At block 710, the logic flow 700 can include performing a verification of an I/O port of the one or more I/O ports based on the port configuration information stored in the RFID device. For example, a controller may determine whether an I/O port is verified to be enabled or disabled based on information stored in a white list or black list in memory of the RFID device. More specifically, the controller may compare an identification of an I/O port attempting to be enabled with information on at least one of the white list and black list to determine if the I/O port is permitted or unpermitted to be enabled or disabled, as previously discussed.

The logic flow 700 can also include causing an action to occur based on whether the I/O port has been verified or not verified at block 715. For example, an alert may be communicated to another device or system, e.g. a local and/or a remote device. In another example, a log may be generated and communicated to a local or remote device. In a third example, the I/O port may be disable and/or the platform may be disabled. If the I/O port is verified, the I/O port may be allowed to operate, and notification may be sent to a remote or local device send a notification to a local or remote device indicating that the current port configuration has been verified. Embodiments are not limited to these examples.

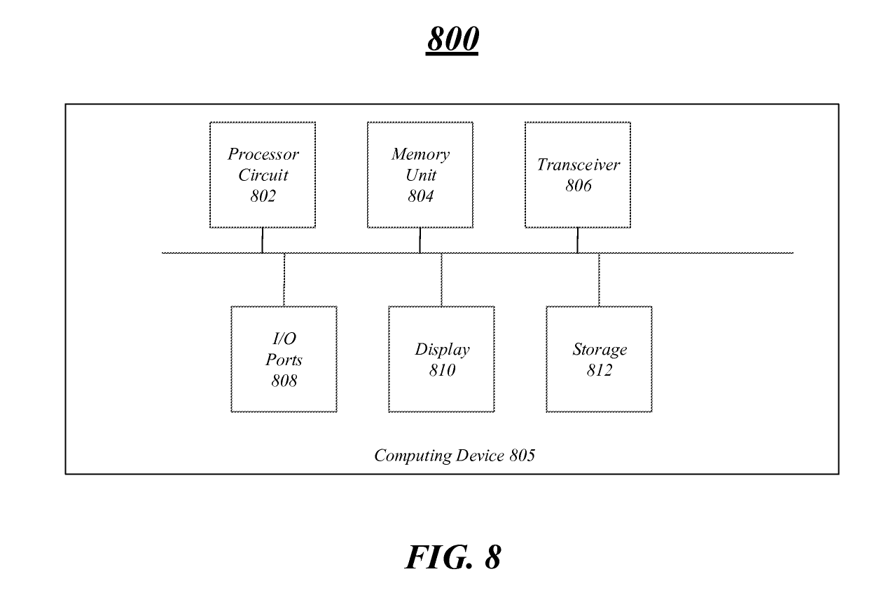

FIG. 8 illustrates an embodiment of a computing device 805. In various embodiments, computing device 805 may be representative of a computing device or system for use with one or more embodiments described herein, such as those discussed in FIGS. 1-8B.

In various embodiments, computing device 805 may be any type of computing device including a computing device including a personal computer (PC), laptop computer, ultra-laptop computer, netbook computer, ultrabook computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a computing device 805 also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a computing device 805 may be implemented as a smart phone capable of executing computer applications, as well as voice communications and/or data communications. Although some embodiments may be described with a computing device 805 implemented as a smart phone by way of example, it may be appreciated that other embodiments may be implemented using other wireless mobile computing devices as well. The embodiments are not limited in this context. In some embodiments, computing device 805 may also be a navigation system, infotainment system, embedded in home appliances, etc.

As shown in FIG. 8, computing device 805 may include multiple elements. One or more elements may be implemented using one or more circuits, components, registers, processors, software subroutine modules, or any combination thereof, as desired for a given set of design or performance constraints. Although FIG. 8 shows a limited number of elements in a certain topology by way of example, it can be appreciated that more or less elements in any suitable topology may be used in computing device 805 as desired for a given implementation. The embodiments are not limited in this context.

In various embodiments, computing device 805 may include one or more processing circuit(s) 802. Processing circuit(s) 802 may be one or more of any type of computational element, such as but not limited to, a microprocessor, a processor, central processing circuit, digital signal processing circuit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit or processing circuitry. The processing circuit(s) 802 may be connected to and communicate with the other elements and components of the computing system via an interconnect 543, such as one or more buses, control lines, and data lines.

In one embodiment, computing device 805 may include memory 804 to couple to processing circuit(s) 802. In various embodiments, the memory 804 may store data and information for use by the computing device 805.

Memory 804 may be coupled to processing circuit(s) 802 via interconnect 853, or by a dedicated communications bus between processing circuit(s) 802 and memory 804, as desired for a given implementation. Memory 804 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory 804 can store instructions and data momentarily, temporarily, or permanently. The memory 804 may also store temporary variables or other intermediate information while the processing circuit(s) 802 is executing instructions. The memory 804 is not limited to storing the above discussed data and may store any type of data.

The computing device 805 may include a transceiver 806 which includes one or more components and circuitry to transmit and receive information using radio-frequency signals. More specifically, the transceiver 806 may include circuitry to produce radio-frequency mobile radio signals which are to be sent and for processing radio-frequency mobile radio signals which have been received. To this end, the transceiver 806 may be coupled to one or more antenna 816. The transmitted or received mobile radio signals are in one or more particular frequency ranges, which are typically prescribed by the mobile radio standard(s) supported by the radio-frequency assemblies. For example, transceiver 806 may include circuitry to process information according to one or more IEEE standards, one or more peer-to-peer protocols, and so forth. Various embodiments are not limited in this manner and transceiver 806 may transmit or receive information via any standard in any frequency range with one more devices, as previously mentioned.

In various embodiments, the transceiver 806 may be used to communicate with one or more other devices or stations via one or more antennas. The transceiver 806 may send and receive information from the stations as one or more pockets, frames, and any other transmission structure in accordance with one or more protocols.

The computing device 805 may include one or more input/output ports or adapters 808. Examples of I/O adapter 808 may include Universal Serial Bus (USB) ports/adapters, IEEE 1394 Firewire ports/adapters, and so forth. The embodiments are not limited in this context.

The computing device 805 may also include a display 810. Display 810 may constitute any display device capable of displaying information received from processor units 802, such as liquid crystal display (LCD), cathode ray tube (CRT) display, a projector, and so forth. Various embodiments are not limited in this manner.

The computing device 805 may also include storage 812. Storage 812 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 812 may include technology to increase the storage performance enhanced protection for valuable digital media when multiple hard drives are included, for example. Further examples of storage 812 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

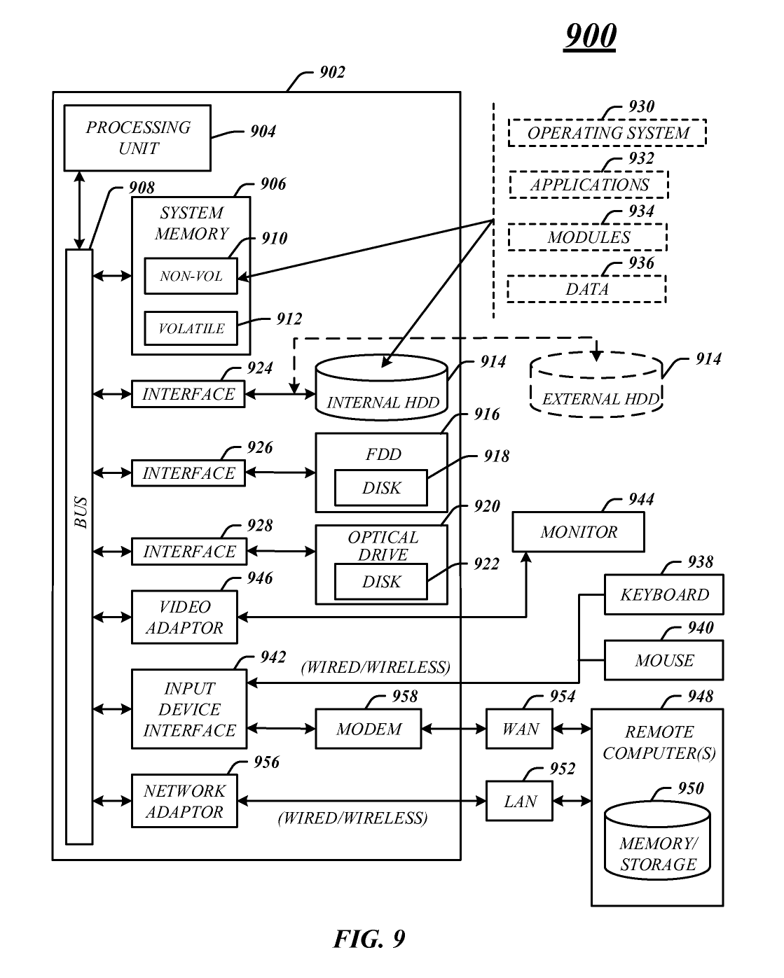

FIG. 9 illustrates an embodiment of an exemplary computing architecture 900 suitable for implementing various embodiments and as previously described. In one embodiment, the computing architecture 900 may include elements, features, components at least partially implemented as part of device 101.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 includes a processing unit 904, a system memory 906 and a system bus 908. The processing unit 904 can be any of various commercially available processors.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), a Gigabit Ethernet port, a hot pluggable storage port, and the like.

The computing architecture 900 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 902 family of standards, such as wireless devices operatively disposed in wireless communication (e.g., IEEE 902.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 902.11x (a, b, g, n, etc.) to provide secure, reliable, fast wireless connectivity. A Wi-Fi network can be used to connect computers to each other, to the Internet, and to wire networks (which use IEEE 902.3-related media and functions).

The various elements of the systems as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through twenty-five (1-25) provided below are intended to be exemplary and non-limiting.

In a first example, a system, device, apparatus may include one or more I/O ports, a radio frequency identification (RFID) device comprising a memory to store port configuration information indicating whether each of the one or more I/O ports are permitted or unpermitted for use, and a controller coupled with the one or more I/O ports and the RFID device to perform a verification of an I/O port of the one or more I/O ports based on the port configuration information stored in the RFID device, and cause an action to occur based on whether the I/O port has been verified or not verified.

In a second example and in furtherance of the first example, a system, device, apparatus may include the controller to perform the verification of the I/O port during a boot operation.

In a third example and in furtherance of any previous example, a system, device, apparatus may include the controller to detect an attempt to enable an I/O port during a run-time operation and to cause an interrupt to perform the verification during the run-time operation.

In a fourth example and in furtherance of any previous example, a system, device, apparatus may include the controller to enable a secure mode to perform the verification during the run-time operation.

In a fifth example and in furtherance of any previous example, a system, device, apparatus may include the controller to enable verification by a remote device by communicating at least one of a hash value of the port configuration information and the port configuration to the remote device via one or more connections.

In a sixth example and in furtherance of any previous example, a system, device, apparatus may include the controller to generate a hash value using the port configuration information stored in the RFID device, compare the hash value with a verified hash value stored in a secure memory, and validate or invalidate the port configuration information based on the comparison.

In a seventh example and in furtherance of any previous example, a system, device, apparatus may include the controller to receive update information for the port configuration information, verify the update information based on a signature, and enable one or more write operations to update the port configuration information in the RFID device when the update information is verified.

In an eighth example and in furtherance of any previous example, a system, device, apparatus may include the controller to receive the update information from a remote device via an RFID reader/writer communicating using an RFID frequency.

In a ninth example and in furtherance of any previous example, a system, device, apparatus may include the action comprising at least one of enabling the I/O port, disabling the I/O port, generating an alert, and disabling a platform device comprising the controller, the RFID device, and the one or more I/O ports.

In a tenth example and in furtherance of any previous example, a method may include receiving port configuration information from a radio frequency identification (RFID) device, the port configuration information indicating whether one or more I/O ports are permitted or unpermitted for use, performing a verification of an I/O port of one or more I/O ports based on the port configuration information stored in the RFID device, and causing an action to occur based on whether the I/O port has been verified or not verified.

In an eleventh example and in furtherance of any previous example, a method may include performing the verification of the I/O port during a boot operation or a run-time operation, and causing an interrupt to perform the verification during the run-time operation.

In a twelfth example and in furtherance of any previous example, a method may include

In a thirteenth example and in furtherance of any previous example, a method may include enabling verification by a remote device by communicating at least one of a hash value of the port configuration information and the port configuration to the remote device via one or more connections.

In a fourteenth example and in furtherance of any previous example, a method may include generating a hash value using the port configuration information stored in the RFID device, comparing the hash value with a verified hash value stored in a secure memory, and validating or invalidating the port configuration information based on the comparison.

In a fifteenth example and in furtherance of any previous example, a method may include receiving update information for the port configuration information from a remote device via an RFID reader/writer device communicating using an RFID frequency, verifying the update information based on a signature, and enabling one or more write operations to update the port configuration information in the RFID device when the update information is verified.

In a sixteenth example and in furtherance of any previous example, a method may include causing the action comprising at least one of enabling the I/O port, disabling the I/O port, generating an alert, and disabling a platform device comprising a controller, the RFID device, and the one or more I/O ports.

In a seventeenth example and in furtherance of any previous example, a non-transitory computer-readable storage medium may include a plurality of instructions that when executed enable processing circuitry to receive port configuration information from a radio frequency identification (RFID) device, the port configuration information indicating whether one or more I/O ports are permitted or unpermitted for use, perform a verification of an I/O port of one or more I/O ports based on the port configuration information stored in the RFID device, and cause an action to occur based on whether the I/O port has been verified or not verified.

In an eighteenth example and in furtherance of any previous example, a non-transitory computer-readable storage medium may include a plurality of instructions that when executed enable processing circuitry to perform the verification of the I/O port during a boot operation or a run-time operation and cause an interrupt to perform the verification during the run-time operation.

In a nineteenth example and in furtherance of any previous example, a non-transitory computer-readable storage medium may include a plurality of instructions that when executed enable processing circuitry to enable processing circuitry to enabling a secure mode to perform the verification during the run-time operation.

In a twentieth example and in furtherance of any previous example, a non-transitory computer-readable storage medium may include a plurality of instructions that when executed enable processing circuitry to enable verification by a remote device by communicating at least one of a hash value of the port configuration information and the port configuration to the remote device via one or more connections.

In a twenty-first example and in furtherance of any previous example, a non-transitory computer-readable storage medium may include a plurality of instructions that when executed enable processing circuitry to generate a hash value using the port configuration information stored in the RFID device, compare the hash value with a verified hash value stored in a secure memory and validate or invalidate the port configuration information based on the comparison.

In a twenty-second example and in furtherance of any previous example, a non-transitory computer-readable storage medium may include a plurality of instructions that when executed enable processing circuitry to receive update information for the port configuration information from a remote device via an RFID reader/writer device communicating using an RFID frequency, verify the update information based on a signature, and enable one or more write operations to update the port configuration information in the RFID device when the update information is verified.

In a twenty-third example and in furtherance of any previous example, a non-transitory computer-readable storage medium may include a plurality of instructions that when executed enable processing circuitry to cause the action comprising at least one of enabling the I/O port, disabling the I/O port, generating an alert, and disabling a platform device comprising a controller, the RFID device, and the one or more I/O ports.

In a twenty-fourth example and in furtherance of any previous example, a system, device, or apparatus may include a memory to store port configuration information indicating whether one or more I/O ports are permitted or unpermitted for use and a transceiver to communicate the port configuration using a radio frequency identification (RFID) frequency.

In a twenty-fifth example and in furtherance of any previous example, a system, a device, an apparatus may include the port configuration information comprising a white list of permitted I/O ports, a black list of unpermitted I/O ports, and block identity structure including a platform identification (ID) to uniquely identify a platform or and a plurality element descriptors to identify the one or more I/O ports.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
one or more I/O ports,
a radio frequency identification (RFID) device comprising a memory to store port configuration information indicating whether each of the one or more I/O ports are permitted or unpermitted for use; and
a controller coupled with the one or more I/O ports and the RFID device to perform a verification of an I/O port of the one or more I/O ports based on the port configuration information stored in the RFID device, and cause an action to occur based on whether the I/O port has been verified or not verified.

2. The apparatus of claim 1, the controller to perform the verification of the I/O port during a boot operation.

3. The apparatus of claim 1, the controller to detect an attempt to enable an I/O port during a run-time operation and to cause an interrupt to perform the verification during the run-time operation.

4. The apparatus of claim 3, the controller to enable a secure mode to perform the verification during the run-time operation.

5. The apparatus of claim 1, the controller to enable verification by a remote device by communicating at least one of a hash value of the port configuration information and the port configuration to the remote device via one or more connections.

6. The apparatus of claim 1, the controller to generate a hash value using the port configuration information stored in the RFID device, compare the hash value with a verified hash value stored in a secure memory, and validate or invalidate the port configuration information based on the comparison.

7. The apparatus of claim 1, the controller to receive update information for the port configuration information, verify the update information based on a signature, and enable one or more write operations to update the port configuration information in the RFID device when the update information is verified.

8. The apparatus of claim 7, the controller to receive the update information from a remote device via an RFID reader/writer communicating using an RFID frequency.

9. The apparatus of claim 1, the action comprising at least one of enabling the I/O port, disabling the I/O port, generating an alert, and disabling a platform device comprising the controller, the RFID device, and the one or more I/O ports.

10. A computer-implemented method, comprising:
receiving port configuration information from a radio frequency identification (RFID) device, the port configuration information indicating whether one or more I/O ports are permitted or unpermitted for use;
performing a verification of an I/O port of one or more I/O ports based on the port configuration information stored in the RFID device; and
causing an action to occur based on whether the I/O port has been verified or not verified.

11. The computer-implemented method of claim 10, comprising:
performing the verification of the I/O port during a boot operation or a run-time operation; and
causing an interrupt to perform the verification during the run-time operation.

12. The computer-implemented method of claim 11, comprising enabling a secure mode to perform the verification during the run-time operation.

13. The computer-implemented method of claim 10, comprising enabling verification by a remote device by communicating at least one of a hash value of the port configuration information and the port configuration to the remote device via one or more connections.

14. The computer-implemented method of claim 10, comprising:
generating a hash value using the port configuration information stored in the RFID device;
comparing the hash value with a verified hash value stored in a secure memory; and
validating or invalidating the port configuration information based on the comparison.

15. The computer-implemented method of claim 10, comprising:
receiving update information for the port configuration information from a remote device via an RFID reader/writer device communicating using an RFID frequency;
verifying the update information based on a signature; and
enabling one or more write operations to update the port configuration information in the RFID device when the update information is verified.

16. The computer-implemented method of claim 10, causing the action comprising at least one of enabling the I/O port, disabling the I/O port, generating an alert, and disabling a platform device comprising a controller, the RFID device, and the one or more I/O ports.

17. A non-transitory computer-readable storage medium comprising a plurality of instructions that when executed enable processing circuitry to:
receive port configuration information from a radio frequency identification (RFID) device, the port configuration information indicating whether one or more I/O ports are permitted or unpermitted for use;
perform a verification of an I/O port of one or more I/O ports based on the port configuration information stored in the RFID device; and
cause an action to occur based on whether the I/O port has been verified or not verified.

18. The non-transitory computer-readable storage medium of claim 17, further comprising the plurality of instructions that when executed enable processing circuitry to:
perform the verification of the I/O port during a boot operation or a run-time operation; and
cause an interrupt to perform the verification during the run-time operation.

19. The non-transitory computer-readable storage medium of claim 17, further comprising the plurality of instructions that when executed enable the processing circuitry to enable processing circuitry to enabling a secure mode to perform the verification during the run-time operation.

20. The non-transitory computer-readable storage medium of claim 17, further comprising the plurality of instructions that when executed enable the processing circuitry to enable verification by a remote device by communicating at least one of a hash value of the port configuration information and the port configuration to the remote device via one or more connections.

21. The non-transitory computer-readable storage medium of claim 17, further comprising the plurality of instructions that when executed enable the processing circuitry to:
generate a hash value using the port configuration information stored in the RFID device;
compare the hash value with a verified hash value stored in a secure memory; and
validate or invalidate the port configuration information based on the comparison.

22. The non-transitory computer-readable storage medium of claim 17, further comprising the plurality of instructions that when executed enable the processing circuitry to:
receive update information for the port configuration information from a remote device via an RFID reader/writer device communicating using an RFID frequency;
verify the update information based on a signature; and
enable one or more write operations to update the port configuration information in the RFID device when the update information is verified.

23. The non-transitory computer-readable storage medium of claim 17, further comprising the plurality of instructions that when executed enable the processing circuitry to cause the action comprising at least one of enabling the I/O port, disabling the I/O port, generating an alert, and disabling a platform device comprising a controller, the RFID device, and the one or more I/O ports.

24. An apparatus, comprising:
a memory to store port configuration information indicating whether one or more I/O ports are permitted or unpermitted for use; and
a transceiver to communicate the port configuration using a radio frequency identification (RFID) frequency.

25. The apparatus of claim 24, the port configuration information comprising a white list of permitted I/O ports, a black list of unpermitted I/O ports, and block identity structure including a platform identification (ID) to uniquely identify a platform or and a plurality element descriptors to identify the one or more I/O ports.
